(19) United States
(12) Patent Application Publication
(10) Pub. No.: US 2008/0235367 A1
(43) Pub. Date: Sep. 25, 2008

(54) METHOD AND APPARATUS FOR UPDATING USER STATUS IN AN INSTANT MESSAGING SYSTEM

(76) Inventors: Terry Wade Niemeyer, Austin, TX (US); Liliana Orozco, Del Valle, TX (US)

Correspondence Address: IBM CORP (YA);C/O YEE & ASSOCIATES PC, P.O. BOX 802333, DALLAS, TX, 75380, US

(21) Appl. No.: 11/689,724

(22) Filed: Mar. 22, 2007

(51) Int. Cl. G06F 15/173

(52) U.S. Cl. 709/224

(57) ABSTRACT

A computer implemented method, apparatus and computer usable program code for managing user status. A number of active conversations present for a user of an instant messaging service is identified. The user status for the user is changed based on a policy using the number of active conversations.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code for updating user status in an instant messaging system.

2. Description of the Related Art

Instant messaging is an on-line chat medium. This type of medium allows users to communicate with each other and collaborate in real time over a network data processing system. Instant messaging is commonly used over the Internet. Instant messaging applications monitor and report the status of users that have established each other as on-line contacts. These on-line contacts are also referred to as buddy lists. This information is generally presented to the user in a window. Instant messaging applications are also often used by users conducting business. Through the use of instant messaging, business users may view each other's availability and initiate a text conversation with colleges or customers when a desired contact becomes available.

Typically, with instant messaging applications, communications between users are initiated by the users selecting the name of the person with which they desire to communicate. Then, the users type messages in a dialog box in the window and press “send”. These messages then appear “instantly” on the selected recipients' computer.

Users often have more than one window open with other users simultaneously. For example, a user may have two windows open in which the user is actively communicating with two other users. In other cases, a user may have, for example, forty windows open in which forty conversations are being conducted by the user with other users.

As the number of active conversations increase, it becomes increasingly difficult to quickly respond to all of the users with which conversations are occurring. Further, the user may lose the train of thought for different conversations because of the large number of active conversations that are currently ongoing with other users. These other users do not realize how many conversations may be ongoing and may wonder why responses are taking longer than expected. With this type of situation, the usefulness of obtaining quick responses for instant replies is reduced.

### SUMMARY OF THE INVENTION

The illustrative embodiments provide a computer implemented method, apparatus and computer usable program code for managing user status. A number of active conversations present for a user of an instant messaging service is identified. The user status for the user is changed based on a policy using the number of active conversations.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram illustrating software components in an instant messaging system in accordance with an illustrative embodiment;

FIG. 4 is a diagram illustrating components used in an instant messaging system in accordance with an illustrative embodiment;

FIG. 5 is a diagram illustrating a display in an instant messaging client in accordance with an illustrative embodiment;

FIG. 6 is a flowchart of a process for identifying active conversations in accordance with an illustrative embodiment;

FIG. 7 is a flowchart of a process for identifying the count of active conversations in accordance with an illustrative embodiment;

FIG. 8 is a flowchart of a process for changing a status of a user using a policy in accordance with an illustrative embodiment; and

FIG. 9 is a flowchart of a process for presenting status information in accordance with an illustrative embodiment.

### DETAILED DESCRIPTION OF THE PREFERRED EMBODIMENT

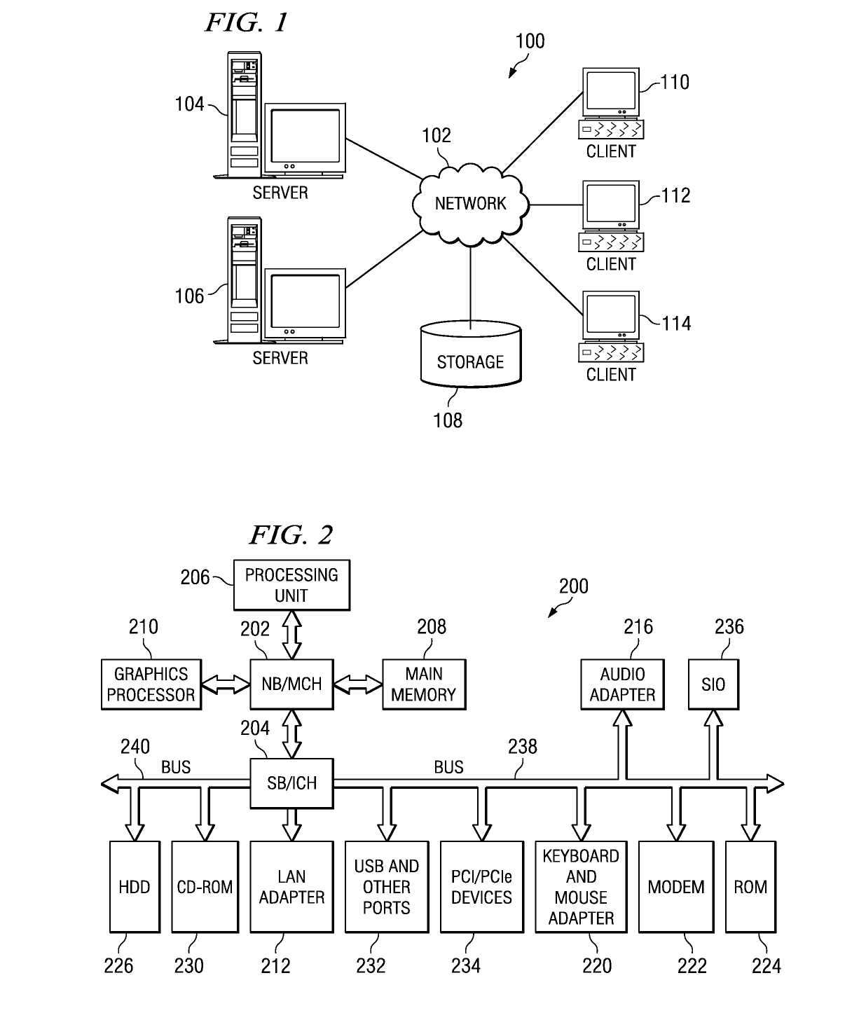

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. In particular, server 104 and server 106 may provide instant messaging services to clients 110, 112, and 114. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The different embodiments provide a computer implemented method, apparatus, and computer usable program code for managing user status. The management of user status allows for a user to inform other users as to the number of active conversations that the user may have. The number of active conversations present for a user of an instant message service is identified. The number of active conversations is sent to a server for the instant messaging service. The status of the user may be changed based on the policy using the number of active conversations that the user has. Further, the number of active conversations present for the user may be sent to other users of the instant messaging service by the server in these examples.

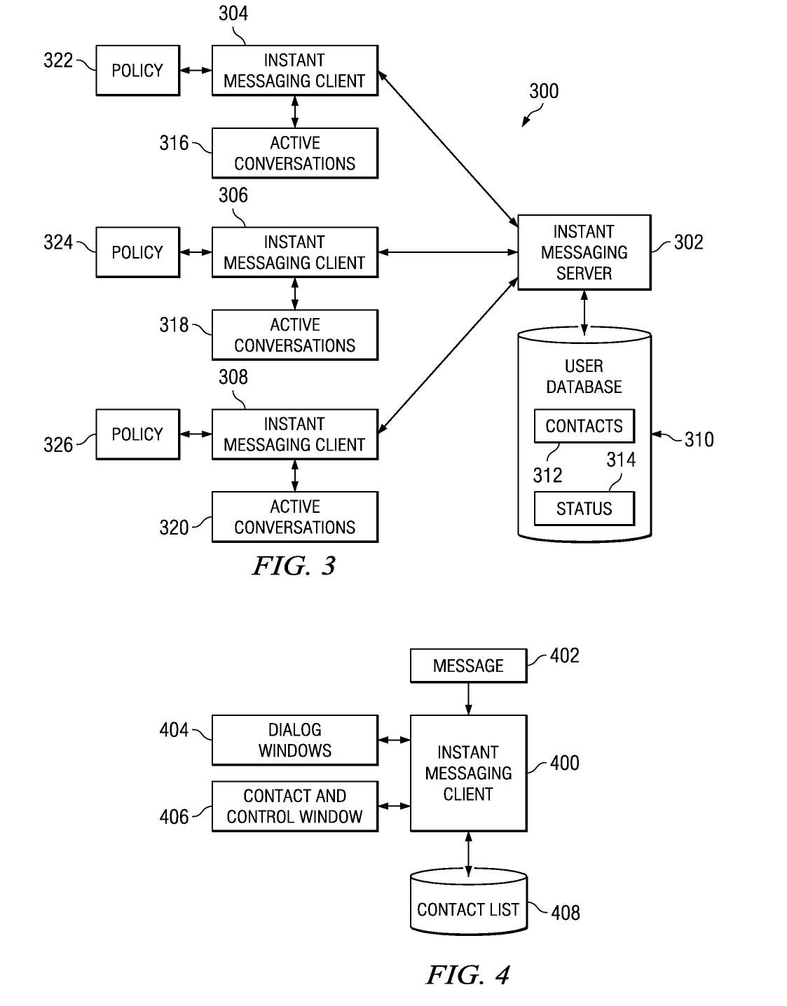

Turning now to FIG. 3, a diagram illustrating software components in an instant messaging system is depicted in accordance with an illustrative embodiment. In these examples, instant messaging system 300 provides an instant messaging service to users through the use of server and client applications. Instant messaging system 300 may be implemented in a network data processing system, such as network data processing system 100 in FIG. 1.

In these examples, instant messaging server 302 provides instant messaging services to instant messaging clients 304, 306, and 308. Instant messaging server 302 may be implemented on a server, such as server 104 in FIG. 1. Instant messaging clients 304, 306, and 308 may be implemented on data processing systems, such as clients 110, 112, and 114 in FIG. 1. These clients may execute on various types of data processing systems, such as computers, personal digital assistants (PDAs), and mobile phones.

In these illustrative examples, instant messaging server 302 provides login services for instant messaging clients 304, 306, and 308. Further, instant messaging server 302 also contains user database 310. This database contains contacts 312 and status 314. Contacts 312 contain the contacts for each user that is registered for the instant messaging service provided through instant messaging server 302. Contacts 312 list other users that are part of the instant messaging service. For example, when a user at instant messaging client 304 logs on, instant messaging server 302 validates the user at that client and also sends contacts for the user from contacts 312 to instant messaging client 304.

When the user at instant messaging client 304 desires to initiate a conversation with another user, instant messaging client 304 sends a request to instant messaging server 302 to send the message to the other user at the appropriate instant messaging client. Depending on the particular implementation, the instant messaging clients may contact each other directly through a peer-to-peer type mechanism.

In these depicted examples, instant messaging server 302 also provides status information, which is stored in status 314 within user database 310. This status information includes information as to the status of a particular user, such as active, away, or do not disturb. Further, in these illustrative embodiments, status 314 also includes information about the number of active conversations that a user has on a particular instant messaging client.

In these illustrative examples, instant messaging clients 304, 306, and 308 track the number of active conversations that users at those clients are engaging in with other users. In this example, different users are using instant messaging clients 304, 306, and 308. In these examples, instant messaging client 304 has active conversations 316; instant messaging client 306 has active conversations 318; and instant messaging client 308 has active conversations 320.

Each of these instant messaging clients identifies the number of active conversations present and sends that information to instant messaging server 302 in these illustrative embodiments. This number of active conversations for a particular user is stored within status 314 in user database 310 in these examples. This status information may then be sent to other users that have the particular user as a contact on their contact list. In this manner, other users may see how many active conversations a particular user has. Thus, a user may understand why responses are taking longer than normally expected based on the number of active conversations present for a particular user.

Further, in these illustrative examples, instant messaging client 304 may automatically change the status of a user based on a policy. As depicted, instant messaging client 304 contains policy 322; instant messaging client 306 contains policy 324; and instant messaging client 308 contains policy 326. In these examples, these policies dictate when a status of a user changes.

For example, the status of a user may change from available to unavailable based on a threshold value set within these policies. This unavailable status may be for example, “away from the computer”, “do not disturb”, “I am away”, or some other status indicating that the user is unavailable to chat or exchange messages. The status may change from unavailable to available if the number of active conversations crosses a threshold value set in the policy. This threshold value may be the same one as the one used to change the status from available to busy.

Alternatively, a different threshold value may be set depending on the user preferences. In these examples, the threshold values set in policies 322, 324, and 326 are user configurable. In this manner, each user may determine when they have exceeded the number of active conversations that the user feels the user is able to handle efficiently.

In these examples, active conversations are the number of active conversations in which a user is participating. Identifying an active conversation may be performed using a number of different mechanisms. For example, the number of active conversations for each user may be stored at instant messaging server 302 as described in these embodiments. In this depicted embodiment, an instant messaging client, such as instant messaging client 304 reports to instant messaging server 302 each time a window is opened or closed for a conversation with another user. Another example of a threshold that may be used to determine the number of active conversations is to identify the number of instant messaging windows or the number of active windows in which a user has entered input within a selected window of time.

Alternatively, the number of conversations may be tracked by instant messaging client 304 and reported to instant messaging server 302 in response to an event. This event may be a periodic event, such as a timer or another event, such as a request for an update of user status by a user at another instant messaging client.

In these examples, if instant messaging server 302 tracks the conversation, an active conversation lasts from the moment a user opens a window to contact another user to the moment both users close their windows or until one user becomes inactive. Alternatively, the active conversation may end when one user closes their window. If active conversations are tracked by instant messaging clients, an active conversation lasts from the moment a user starts typing or someone contacts that user to the moment when the user closes the window or the other user changes their status to inactive.

In these examples, the instant messaging client may track the number of active conversations. In this case, the instant messaging client, such as instant messaging client 304, reports to instant messaging server 302 every time the number of active conversation changes for that instant messaging client. When other users at instant messaging client 304 refresh their contact list, those users may see how many active conservations that each user on their contact list has in progress. Further, depending on the resource availability, the active conservation count may be queried only when one user opens the window to contact another user. Also, depending on the implementation, a count of active conservations may include only conservations in which a window is not minimized. Windows that are minimized for conservations are not counted towards the total number of active conservations in this alternative embodiment.

Also, depending on the implementation, multiple servers may be present that provide instant messaging services. With multiple servers, the tracking of conversations may be coordinated by the servers accessing a single database containing the information on the number of conversations for each user. Alternatively, each server may track the information separately and send and receive updates to keep the information current.

Turning next to FIG. 4, a diagram illustrating components used in an instant messaging system are depicted in accordance with an illustrative embodiment. In the depicted example, instant messaging client 400 processes messages, such as message 402, received from users using instant messaging clients located on remote data processing systems. As messages are received, these messages are presented in dialog windows 404. Messages exchanged between instant messaging client 400 and an instant messaging application on a remote data processing system form a conversation in these examples.

Additionally, dialog windows 404 provide an interface for user input to send messages to other users. Contact and control window 406 is presented by instant messaging client 400 to provide the user with a list of user names, as well as other information, such as, for example, identifying other users that are currently on-line. Contact and control window 406 also provides an interface to allow the user to set different preferences. For example, the user may set passwords required to access different names used in instant messaging sessions. Further, a user may employ contact and control window 406 to set other preferences, such as colors and fonts used in instant messaging client 400.

Further, the list of names presented by contact and control window 406 is stored in contact list 408 in these examples. Additional user names may be added or deleted from contact list 408. This contact list is employed in presenting the list of names within contact and control window 406. Additionally, the user may view the status of other users on contact and control window 406. This status may be, for example, available or unavailable. When the status is available, instant messaging client 400 will accept messages from another instant messaging application to start a new conversation.

When the status of another user is unavailable, messages from instant messaging client 400 are typically not accepted by the other application for that user. The different embodiments include processes in instant messaging client 400 for tracking the number of active conversations that a user currently has. The processes also provide for displaying the number of active conversations for users on a contact list presented by contact and control window 406 in these examples.

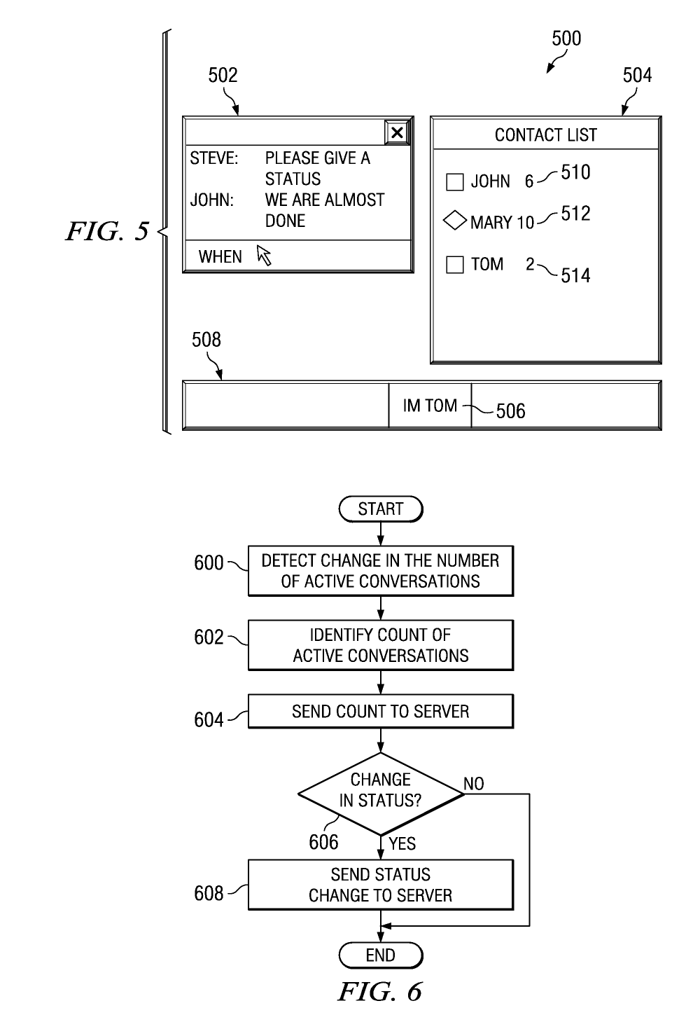

Turning now to FIG. 5, a diagram illustrating a display in an instant messaging client is depicted in accordance with an illustrative embodiment. In this example, display 500 contains conversation dialog 502 and contact list 504. Conversation dialog 502 is an example of a dialog window in dialog windows 404 in FIG. 4. Contact list 504 is an example of a window, such as contact and control window 406 in FIG. 4.

In this example, conversation dialog 502 is a window in which an active conversation is taking place. This dialog window included is in a count of active conversations. Within display 500, minimized conversation dialog 506 is shown in bar 508. Depending on the particular implementation, minimized conversation dialog 506 may or may not be counted as an active conversation. Contact list 504 contains contacts 510, 512 and 514. Each of these contacts contains a name or identifier for the contact as well as a status of the contact. The status of the contact indicates whether the particular user is available for conversations as well as the number of active conversations that the user is currently participating in with other users.

In this example, contact 510 is available and has six active conversations. Contact 512 is unavailable and has ten active conversations. Contact 514 is available with two active conversations.

Turning now to FIG. 6, a flowchart of a process for identifying active conversations is depicted in accordance with an illustrative embodiment. The process illustrated in FIG. 6 may be implemented in an instant messaging client, such as instant messaging client 304 in FIG. 3.

The process begins by detecting a change in the number of active conversations present for the user (step 600). Thereafter, the count of active conversations is identified (step 602). This count is then sent to a server (step 604). In these examples, this server is an instant messaging server, such as instant messaging server 302 in FIG. 3, which provides an instant messaging service. Next, a determination is made as to whether a change in status for the user should occur (step 606). The determination in step 606 may be made using a policy, such as policy 322 in FIG. 3. For example, if the number of active conversations that have been counted for the user has crossed a threshold, the status may be changed.

If the status is to be changed, the status change is then sent to the server (step 608) with the process terminating thereafter. Otherwise, the process terminates without sending a status change to the server.

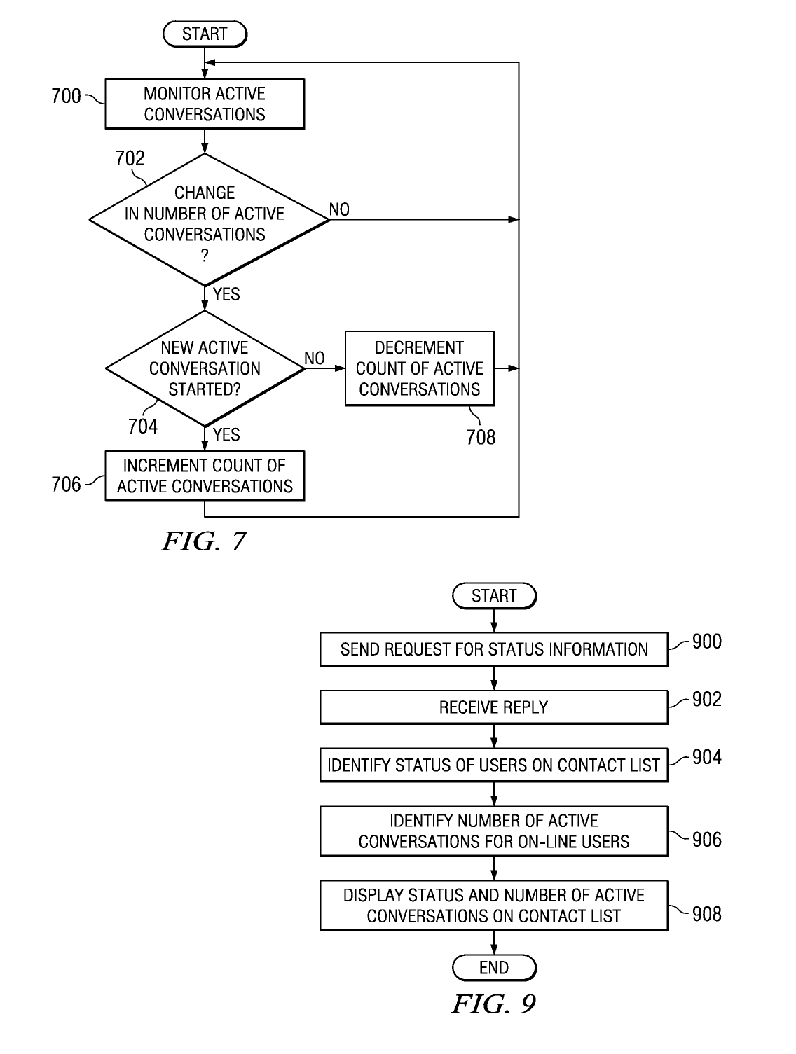

With reference next to FIG. 7, a flowchart of a process for identifying the count of active conversations is depicted in accordance with an illustrative embodiment. The process illustrated in FIG. 7 may be implemented in an instant message client, such as instant messaging client 304 in FIG. 3.

The process begins by monitoring the active conversations for a user (step 700). A determination is made as to whether change in the number of active conversations has occurred (step 702). If the number of active conversations has not changed, the process returns to step 700. Otherwise, a determination is made as to whether a new active conversation has been started (step 704).

If a new active conversation has been started, the count of active conversations is incremented (step 706) with the process then returning to step 700. With reference again to step 704, if a new active conversation has not been started, then the count of active conservations is decremented (step 708) with the process returning then to step 700 as described above.

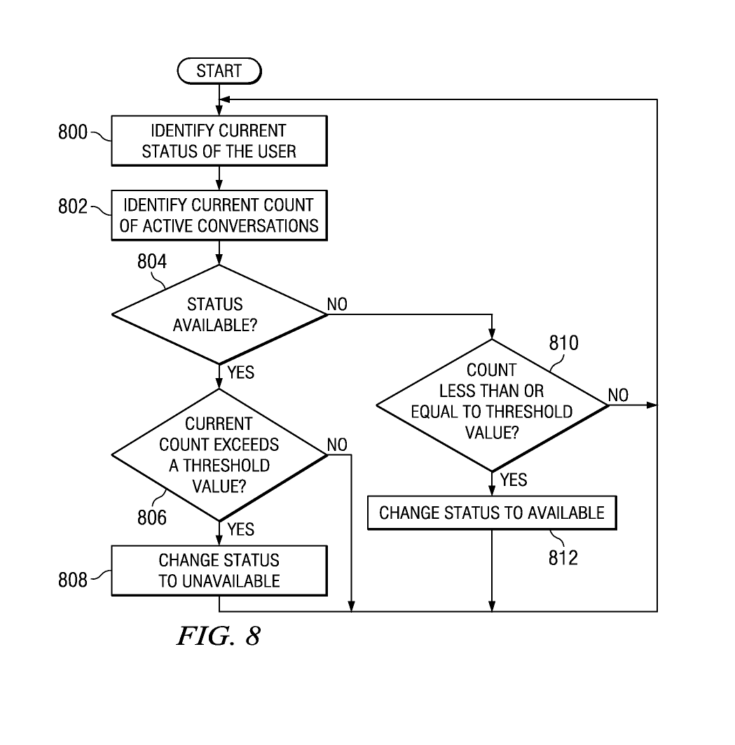

Turning now to FIG. 8, a flowchart of a process for changing a status of a user using a policy is depicted in accordance with an illustrative embodiment. The process illustrated in FIG. 8 may be used to implement step 606 in FIG. 6. The process illustrated in FIG. 8 may be implemented in a client instant messaging system or on an instant messaging server depending on the particular implementation.

The process begins by identifying current status of the user (step 800). This status may be, for example, available or unavailable. Of course, other more specific statuses may be identified depending on the particular implementation. In this example, the status of interest is whether the user is available or unavailable. The types of unavailable statuses may be, for example, busy, away from the computer, or do not disturb.

The current count of active conversations is then identified (step 802). A determination is made as to whether the status is currently available for the user (step 804). If the status is available, a determination is made as to whether the current count exceeds a threshold value (step 806). If the current count does not exceed the threshold value, the process returns to step 800 as described above. Otherwise, the status of the user is changed to unavailable (step 808) with the process then returning to step 800 as described above.

With reference again to step 804, if the status of the user is currently not available, a determination is made as to whether the count of active conversations is less than or equal to the threshold value (step 810). If the count is less than or equal to the threshold value, the status is then changed to available (step 812) with the process then returning to step 800 as described above. If the count is not less than or equal to the threshold value in step 810, the process returns directly to step 800.

Depending on the particular implementation, the determination in step 810 may be made with respect to a different threshold value. The type of determinations made in whether to change the status of a user may vary depending on the policy that has been set.

With reference now to FIG. 9, a flowchart of a process for presenting status information is depicted in accordance with an illustrative embodiment. The process illustrated in FIG. 9 may be implemented in an instant messaging client, such as instant messaging client 304 in FIG. 3.

The process begins by sending a request for status information (step 900). In this example, the request is sent to an instant messaging server that provides the instant messaging service. A reply is received from the instant messaging server (step 902). This reply contains status information for the different contacts on a user's contact list. Thereafter, the status of users on the contact list is identified (step 904). This status information is an identification of whether a user on the contact list is available for a conversation.

Next, the number of active conversations for on-line users is identified (step 906). The status and number of active conversations is then displayed on the contact list (step 908). Step 908 provides a display similar to contact list 504 in FIG. 5. The process then terminates.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different illustrative embodiments provide a computer implemented method, apparatus, and computer usable program code for managing user status. A number of active conversations present for a user of an instant messaging service is identified. This number of active conversations is sent to a server for the instant messaging service. The user status is changed for the user based on the policy depending on the number of active conversations present for the user.

In this manner, the status of the user may be automatically changed depending on the number of active conversations present for that user. In this manner, situations in which a user is participating in too many conversations to provide adequate or quick replies is avoided.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. For example, the number of active conversations does not need to be stored on a server in other embodiments. The number of active conversations may be identified by the instant messaging client and sent to another instant messaging client when requested. In other words, an instant messaging client may request the number of active conversations for each contact listed in a contact list directly from the instant messaging clients for those clients, rather than obtaining them from a server. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a user status, the computer implemented method comprising:
identifying a number of active conversations present for a user of an instant messaging service; and
changing the user status for the user based on a policy using the number of active conversations.

2. The computer implemented method of claim 1, wherein the changing step comprises:
changing the user status from an available status to an unavailable status if the number of active conversations exceed a threshold value.

3. The computer implemented method of claim 1, wherein the changing step comprises:
changing the user status from an unavailable status to an available status if the number of active conversations are equal to or less than a threshold value.

4. The computer implemented method of claim 2, wherein the threshold value is a first threshold value and wherein the changing step further comprises:
changing the user status from the unavailable status to the available status if the number of active conversations are less than a second threshold value.

5. The computer implemented method of claim 1 further comprising:
sending the number of active conversations present for the user to another user that has the user on a contact list, wherein the number of active conversations for the user is presented in a client instant messaging application to the other user.

6. The computer implemented method of claim 1, further comprising:
sending the number of active conversations to the instant messaging service.

7. The computer implemented method of claim 6 further comprising:
obtaining the number of active conversations for each user in a contact list from the instant messaging service; and
presenting the number of active conversations for each user in the contact list.

8. A data processing system comprising:
a bus;
a communications unit connected to the bus;
a storage device connected to the bus, wherein the storage device includes a computer program product; and
a processor unit connected to the bus, wherein the processor unit executes the computer program product to identify a number of active conversations present for a user of an instant messaging service; and change the user status for the user based on a policy using the number of active conversations.

9. The data processing system of claim 8, wherein in executing the computer program product to change the user status for the user based on the policy using the number of active conversations, the processor unit executes the computer program product to change the user status from an available status to an unavailable status if the number of active conversations exceed a threshold value.

10. The data processing system of claim 8, wherein in executing the computer program product to change the user status for the user based on the policy using the number of active conversations, the processor unit executes the computer program product to change the user status from an unavailable status to an available status if the number of active conversations are equal to or less than a threshold value.

11. The data processing system of claim 9, wherein the threshold value is a first threshold value and wherein in executing the computer program product to change the user status for the user based on the policy using the number of active conversations, the processor unit further executes the computer program product to change the user status from the unavailable status to the available status if the number of active conversations are less than a second threshold value.

12. The data processing system of claim 8, wherein the processor unit further executes the computer program product to send the number of active conversations present for the user to another user that has the user on a contact list, wherein the number of active conversations for the user is presented in a client instant messaging application to the other user.

13. The data processing system of claim 8, wherein the processor unit further executes the computer program product to send the number of active conversations to the instant messaging service.

14. A computer program product comprising:
a computer usable medium having computer usable program code for managing a user status, the computer usable product comprising:
computer usable program code for identifying a number of active conversations present for a user of an instant messaging service; and
computer usable program code for changing the user status for the user based on a policy using the number of active conversations.

15. The computer program product of claim 14, wherein the computer usable program code for changing the user status for the user based on the policy using the number of active conversations comprises:
computer usable program code for changing the user status from an available status to an unavailable status if the number of active conversations exceed a threshold value.

16. The computer program product of claim 14, wherein the computer usable program code for changing the user status for the user based on the policy using the number of active conversations comprises:
computer usable program code for changing the user status from an unavailable status to an available status if the number of active conversations are equal to or less than a threshold value.

17. The computer program product of claim 15, wherein the threshold value is a first threshold value and wherein the computer usable program code for changing the user status for the user based on the policy using the number of active conversations further comprises:
computer usable program code for changing the user status from the unavailable status to the available status if the number of active conversations are less than a second threshold value.

18. The computer program product of claim 14 further comprising:
computer usable program code for sending the number of active conversations present for the user to another user that has the user on a contact list, wherein the number of active conversations for the user is presented in a client instant messaging application to the other user.

19. The computer program product of claim 14, further comprising:
computer usable program code for sending the number of active conversations to the instant messaging service.

20. The computer program product of claim 19 further comprising:
computer usable program code for obtaining the number of active conversations for each user in a contact list from the instant messaging service; and
computer usable program code for presenting the number of active conversations for each user in the contact list.
